(19) United States
(12) Patent Application Publication
(10) Pub. No.: US 2024/0161215 A1
(43) Pub. Date: May 16, 2024

(54) SYSTEMS AND METHODS FOR VIRTUAL ATTORNEY CONSULTATIONS AND REFERRALS

(71) Applicant: Law Live, LLC, Philadelphia, PA (US)

(72) Inventors: Joel L. Andre Watson, Copiague, NY (US); Shawn Cohen, Atascocita, TX (US); Adam Dimenna, Philadelphia, PA (US)

(21) Appl. No.: 18/054,790

(22) Filed: Nov. 11, 2022

(51) Int. Cl. G06Q 50/18; G06Q 30/02

(52) U.S. Cl. CPC G06Q 50/18; G06Q 30/0282

(57) ABSTRACT

Systems and methods for arranging a virtual consultation and attorney referral are provided. In the systems and methods, a computing device having a processor receives a request for legal assistance from a prospective client that includes at least one legal issue. The processor alerts available attorneys of the request for legal assistance and then initiates a virtual consultation between the prospective client and an initiating attorney. After the virtual consultation, the processor receives a referral request from the initiating attorney to refer the client to a referral attorney; and determines whether the referral attorney is qualified to represent the prospective client. A handling attorney is then selected between the referral attorney or another available attorney if the referral attorney is determined to be not qualified. After selection of the handling attorney, an attorney-client relationship between handling attorney and prospective client is verified.

### FIELD OF THE DISCLOSURE

The present disclosure relates to methods and systems for arranging referrals and in particular, methods and systems for arranging virtual attorney consultations and attorney referrals.

### BACKGROUND OF THE DISCLOSURE

The internet has made it easier to search for an attorney that matches one's particular needs, as there is no shortage of lawyers, and there are many search engines and websites to facilitate a search for an attorney. However, while searching for an attorney has become dramatically easier in recent years, promptly obtaining effective legal advice for one's particular legal needs is not nearly as simple.

Specifically, many lawyers charge hundreds of dollars for a 30-minute legal consultation, and those costs can be compounded for clients who must take time off work to meet with an attorney because they also work during an attorney's normal business hours. Additionally, because there is oftentimes a surplus of lawyers in a given area, prospective clients may have a tough time determining which lawyer is best for them. Moreover, because a prospective client may not be knowledgeable about their legal issues, the client may schedule a legal consultation with a lawyer that does not actually specialize in the client's area of need. This can result in the prospective client having to find another attorney, which takes more time and results in additional consultation fees.

For attorneys, finding new clients can also be a challenge. In particular, some attorneys pay exorbitant fees for leads on potential clients, and when an attorney is fortunate enough to receive a prospective client referred by another attorney, there is no way to determine the quality of that referral. As such, in the case of a low-quality referral, attorneys may spend time and resources to consult with the prospective client, only for the prospective client to turn out to need legal assistance from a different type of attorney. Moreover, many attorneys have begun working from a home office or virtual office which makes traditional consultations more difficult.

Thus, despite the market for legal consultations and the availability of legal practitioners to provide counsel to prospective clients, it remains difficult to efficiently connect prospective clients with attorneys who fit their needs. The present application addresses these and other challenges related to attorney consultations and referrals.

### SUMMARY OF THE DISCLOSURE

In a first aspect a method for arranging a virtual consultation and attorney referral is provided. In this first aspect, the method is performed by a computing device having a storage medium, instructions stored on the storage medium, and a processor configured by executing the instructions, where first, the computing device receives a request for legal assistance from a prospective client, wherein the request includes at least one legal issue of the prospective client. An initial connection payment or payment bypass request from the prospective client is then accepted. Available attorneys are then alerted of the request for legal assistance of the prospective client. A virtual consultation is then initiated between the prospective client and an initiating attorney upon receiving an initiation request from the initiating attorney, where the initiating attorney is an attorney among the available attorneys. A referral request is then received from the initiating attorney to refer the prospective client to a referral attorney. The computing device with the processor applying the attorney selection module, then determines, whether the referral attorney is qualified to represent the prospective client, wherein the step includes: reviewing a current case load of the referral attorney, determining whether the at least one legal issue of the prospective client matches a practice area of the referral attorney, and determining whether a peer rating of the referral attorney is above a predetermined threshold. The referral attorney is then selected as a handling attorney for the prospective client or another available attorney is selected as the handling attorney if the referral attorney is determined to be not qualified. An attorney-client relationship between the handling attorney and the prospective client is then verified, where the verification includes confirming approval of the attorney-client relationship with the prospective client and the handling attorney.

In another aspect, when receiving the referral request, the processor is configured to reject the referral request unless the processor determines that a predetermined period following initiation of the virtual consultation has lapsed to ensure an adequate period for the virtual consultation. In a further aspect, the predetermined period is 15-30 minutes.

In another aspect, an initial connection fee is provided to the initiating attorney following completion of the virtual consultation, wherein the initial connection fee is fixed or proportionate to the length of time of the virtual consultation.

In another aspect, a lead generation fee is provided to the initiating attorney and the handling attorney, wherein the lead generation for each attorney is proportionate to the length of time spent in virtual connection with the prospective client.

In another aspect, the request for legal assistance from the prospective client further includes a location of the prospective client and the step of determining whether the referral attorney is qualified to represent the prospective client further comprises: comparing the location of the prospective client with location and bar admission information associated with the referral attorney.

In another aspect, when the referral attorney is determined to be not qualified, the handling attorney is selected from a generated list of available attorneys by evaluating one or more of the following characteristics of each of the available attorneys: current case load, practice area, peer rating, billing rate, location, and bar admission.

In a second aspect, a method for a virtual attorney referral is provided. In this second aspect, the method is performed by a computing device having a storage medium, instructions stored on the storage medium, and a processor configured by executing the instructions. First, a virtual consultation is initiated between a first attorney and a prospective client upon receiving an initiation request from the first attorney. A referral request is then received from the first attorney to refer the prospective client to a second attorney. It is then determined whether the second attorney is qualified to take on the prospective client, wherein the determination step includes: reviewing a current case load of the second attorney, determining whether at least one legal issue of the existing client matches a practice area of the second attorney, and determining whether a peer rating of the second attorney is above a predetermined threshold. The second attorney is then selected as a handling attorney for the prospective client or another available attorney is selected as the handling attorney if the second attorney is determined to be not qualified. An attorney-client relationship between handling attorney and prospective client is then verified, wherein the step of verifying the attorney-client relationship includes confirming approval of the attorney-client relationship with the prospective client and the handling attorney.

In another aspect, when receiving the referral request, the processor is configured to reject the referral request unless the processor determines that a predetermined period following initiation of the virtual consultation has lapsed to ensure an adequate period for the virtual consultation. In a further aspect, the predetermined period is 15-30 minutes.

In another aspect, an initial connection fee is provided to the first attorney following completion of the virtual consultation, wherein the initial connection fee is fixed or proportionate to the length of time of the virtual consultation.

In another aspect, a lead generation fee is provided to the first attorney and the handling attorney, wherein the lead generation for each attorney is proportionate to the length of time spent in virtual connection with the prospective client.

In another aspect, the step of determining whether the second attorney is qualified to represent the prospective client further includes: comparing a location of the prospective client with location and bar admission information associated with the second attorney.

In another aspect, when the second attorney is determined to be not qualified, the handling attorney is selected from a generated list of the available attorneys by evaluating one or more of the following characteristics of each of the available attorneys: current case load, practice area, peer rating, billing rate, location, and bar admission.

In a third aspect, a system for virtual consultations and attorney referrals is provided. The system includes a network communication interface, a computer-readable storage medium, and a processor configured to interact with the network communication interface and the computer readable storage medium and execute one or more software modules stored on the storage medium. The software modules include an attorney selection module that when executed configures the processor to: receive a request for legal assistance from a prospective client, wherein the request includes at least one legal issue of the prospective client, receive a referral request from an initiating attorney to refer the prospective client to a referral attorney, and determine whether the referral attorney is qualified to be a handling attorney to represent the prospective client. The software modules also include a payment module that when executed configures the processor to: accept an initial connection payment or a payment bypass request from the prospective client, provide an initial connection fee to the initiating attorney following completion of a virtual consultation, and provide a lead generation fee to the initiating attorney and the handling attorney. The software modules further include a communications module that when executed configures the processor to: alert available attorneys of the request for legal assistance of the prospective client, initiate a virtual consultation between the initiating attorney and the prospective client, and verify an attorney-client relationship between the handling attorney and the prospective client.

In another aspect, the attorney selection module, when executed, configures the processor to receive the referral request only after a predetermined period following initiation of the virtual consultation, wherein the predetermined period is 15-30 minutes.

In another aspect, the payment module, when executed, configures the processor to calculate the initial connection fee, wherein the initial connection fee is fixed or proportionate to the length of time of the virtual consultation.

In another aspect, the payment module, when executed, configures the processor to calculate the lead generation fee for the initiating attorney and the handling attorney, wherein the lead generation for each attorney is proportionate to the length of time spent in virtual connection with the prospective client.

In another aspect, the communications module, when executed, configures the processor to receive a confirmation of approval of the attorney-client relationship from the prospective client and the handling attorney in order to verify the attorney-client relationship.

In another aspect, the attorney selection module, when executed, configures the processor to select the handling attorney based on an automated referral determination, wherein the processor is configured to select the handling attorney from a list of the available attorneys based on one or more of the following characteristics of the available attorneys: current case load, practice area, peer rating, billing rate, location, and bar admission.

### BRIEF DESCRIPTION OF THE DRAWINGS

The systems and methods of the disclosure will be described in more detail below and with reference to the attached drawings in which the same number is used for the same or similar elements.

FIG. 1 discloses a high-level diagram of the present system for virtual consultations and attorney referrals in accordance with one or more embodiments;

FIG. 2A discloses a block diagram of a system server for virtual consultations and attorney referrals in accordance with at least one embodiment disclosed herein;

FIG. 2B display a block diagram of software modules for virtual consultations and attorney referrals in accordance with at least one embodiment disclosed herein;

FIG. 3 displays a block diagram showing an exemplary enrollment and sign-in process for a client user in accordance with at least one embodiment disclosed herein;

FIG. 4 displays a block diagram showing an exemplary enrollment and sign-in process for an attorney (legal professional) user in accordance with at least one embodiment disclosed herein; and

FIG. 5 displays a flow diagram of an exemplary method for arranging a virtual consultation and attorney referral between attorney users and a client user in accordance with one or more embodiments.

### DETAILED DESCRIPTION OF CERTAIN EMBODIMENTS OF THE DISCLOSURE

Disclosed herein are methods and systems for arranging virtual attorney consultations and attorney referrals. More specifically, the present systems and methods include a web application and/or local, for example iOS or Android application, that connects attorneys with prospective clients seeking a legal consultation, and pairs attorney with prospective clients in real time based on the specialties of the attorneys and the legal issues of the prospective clients. Once paired, the prospective client and the attorney can communicate virtually via live audio and/or video chat. The present systems and methods also provide a way for aggregating, tracking and providing information to legal professionals within the web application, thereby providing an online community and professional network for attorneys. The present systems and methods also provide a mechanism for lawyers/attorneys to refer a prospective or existing client to another lawyer/attorney within the network to provide the client with an attorney who better fits their needs. This referral mechanism also allows a referring attorney to monitor the fee contemplated and/or received for the referral, and tracks referrals between different user attorneys within the network to ensure that the attorney referrals are appropriate for the prospective clients. The present systems can also be configured to reject an attorney referral if the referral is not suitable for a prospective client and make its own referral recommendation (“automated referral”) for an attorney within the network based on the legal issues of the prospective client and various attributes of an attorney within the network.

In at least one embodiment, the system receives a request for legal assistance from a prospective client and the request includes one or more legal issues that the prospective client is inquiring about. The system then sends a digital alert (e.g., email, phone notification) to available attorneys in the network of the request for legal assistance. An available attorney who receives the alert can initiate a virtual consultation (e.g., audio or video) with the prospective client to discuss the client's legal issues. Upon determining that the client's legal issues are better handled by an attorney with different legal expertise, the attorney who initiated the consultation can make a referral request to an attorney they are connected with in the network who is better suited to handle the prospective client's legal issues (“referral attorney”) and the system can make a determination as to whether the referral attorney is qualified to handle the prospective client's case. If the referral attorney is qualified, then the system can effectuate an attorney-client relationship between the prospective client and the referral attorney upon receiving confirmation from both parties. Alternatively, instead of making a direct referral, the attorney who initiates the consultation can initiate an automated attorney referral by the system to select an appropriate attorney for the client among the attorneys in the system based on the legal issues of the prospective client and various attributes of an attorney. After the system makes its recommendation for an attorney for the prospective client, system can effectuate an attorney-client relationship between the prospective client and the referral attorney upon receiving confirmation from both parties.

In at least one embodiment, the present system also (1) automatically monitors matters referred from one legal professional to another; (2) uses one or more algorithms to rate the quality of the referral and rate the quality of compensation (e.g., referral fees) for the referring party (considering, among other things, timing of compensation and whether the referring party was compensated in accordance with the terms of the referral or standard practice); and (3) automatically prompts legal professionals currently engaged in a referral relationship of outstanding deliverables and relevant case information using a variety of methods, including but not limited to, email, in-system or in-application messaging and push notifications.

These and other aspects of the present methods and systems are described in further detail below with reference to the accompanying drawing figures, in which one or more illustrated embodiments and/or arrangements are shown. The methods and systems of the present application are not limited in any way to the illustrated embodiments and/or arrangements. It should be understood that the methods and systems as shown in the accompanying figures are merely exemplary of the methods and systems of the present application, which can be embodied in various forms as appreciated by one skilled in the art. Therefore, it is to be understood that any structural and functional details disclosed herein are not to be interpreted as limiting the present methods and systems, but rather are provided as a representative embodiment and/or arrangement for teaching one skilled in the art one or more ways to implement the present methods and systems. Additionally, it is noted that while much of the present systems and methods refers to lawyers and attorneys, in at least embodiments, the present systems and methods can also apply to other legal professionals (e.g., paralegals, patent agents).

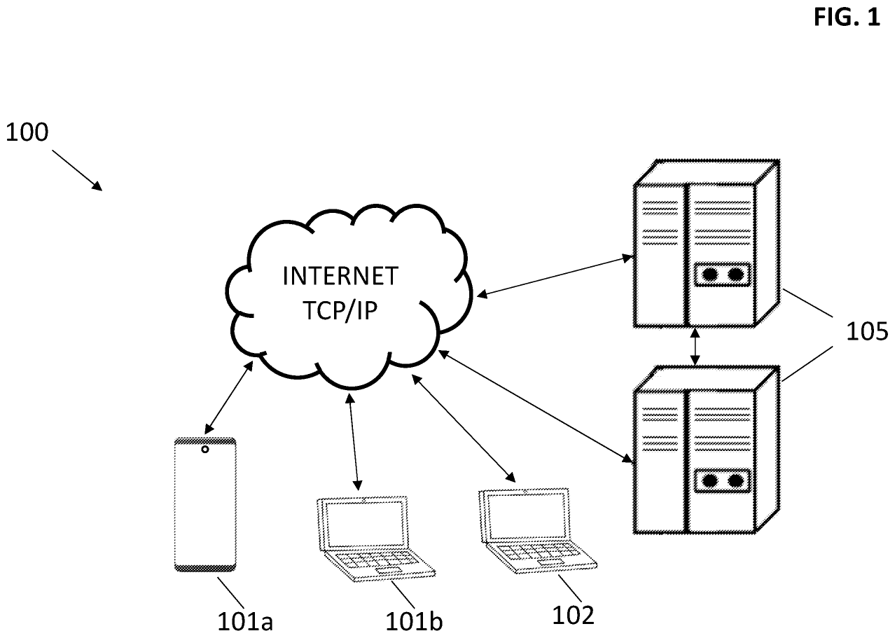

The present methods can be implemented using one or more aspects of the present system as exemplified in FIG. 1. FIG. 1 discloses a high-level diagram of the present system 100 for virtual consultations and attorney referrals in accordance with one or more embodiments. In some implementations, the system includes a cloud-based system server platform that communicates with fixed PC's, servers, and devices such as smartphones, tablets, and laptops operated by users. In one arrangement, the system 100 includes one or more user devices including one or more mobile device(s) 101a and one or more computing devices 101b, and a system server 105. The system 100 can also include one or more remote computing devices 102.

The system server 105 can be practically any computing device and/or data processing apparatus capable of communicating with the user devices and remote computing devices and receiving, transmitting and storing electronic information and processing requests as further described herein. Similarly, the remote computing device 102 can be practically any computing device and/or data processing apparatus capable of communicating with the system server and/or the user devices and receiving, transmitting and storing electronic information and processing requests as further described herein. It should also be understood that the system server 105 and/or remote computing device 102 can be a number of networked or cloud-based computing devices.

In one or more embodiments, the user devices—mobile device 101a and user computing device 101b—can be configured to communicate with one another, the system server 105 and/or remote computing device 102, transmitting electronic information thereto and receiving electronic information therefrom. The user devices can be configured to transmit and receive signals (e.g., messages, requests, phone calls, video calls, videos, etc.) corresponding to one or more interactions by a user with the system 100.

The mobile device 101a can be any mobile computing devices and/or data processing apparatus capable of embodying the systems and/or methods described herein, including but not limited to a personal computer, tablet computer, personal digital assistant, mobile electronic device, cellular telephone or smart phone device and the like. The computing device 101b is intended to represent various forms of computing devices that a user can interact with, such as workstations, a personal computer, laptop computer, access control devices or other appropriate digital computers.

It should be noted that while FIG. 1 depicts the system 100 for virtual consultations and attorney referrals with respect to a mobile device 101a and a user computing device 101b and a remote computing device 102, it should be understood that any number of such devices can interact with the system 100 in the manner described herein. It should also be noted that any number of users can interact with the system in the manner described herein. It should be further understood that while the various computing devices and machines referenced herein, including but not limited to mobile device 101a, computing device 101b, system server 105, and remote computing device 102 are referred to herein as individual/single devices and/or machines, in certain implementations the referenced devices and machines, and their associated and/or accompanying operations, features, and/or functionalities can be combined or arranged or otherwise employed across a number of such devices and/or machines, such as over a network connection or wired connection, as is known to those of skill in the art.

It should also be understood that while the exemplary systems and methods described herein are often described in the context of the mobile device 101a (e.g., smartphone), the present systems and methods are not specifically limited to the mobile device and can be implemented using other enabled computing devices (e.g., user computing device 101b).

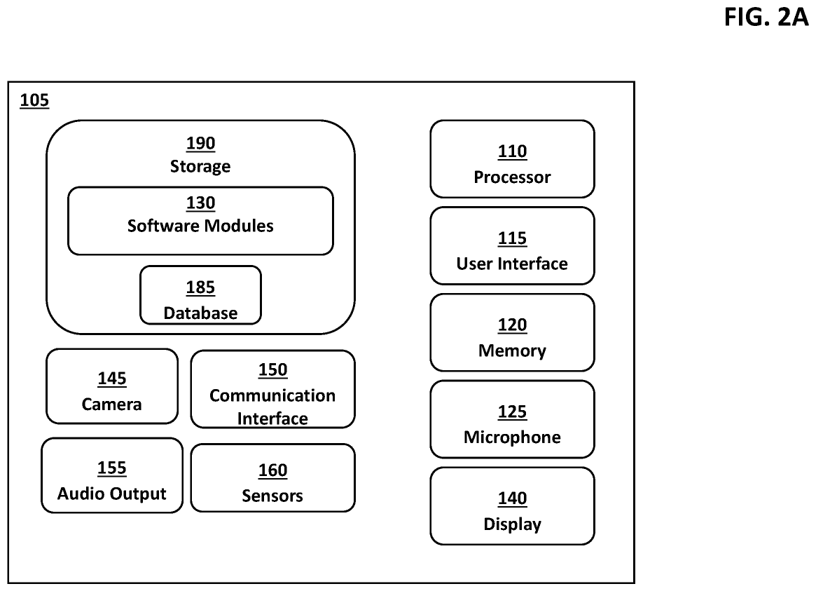

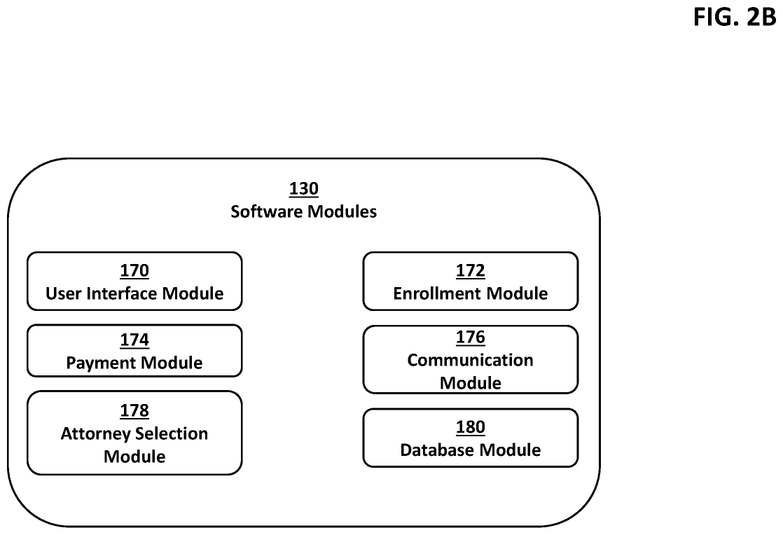

FIG. 2A discloses a block diagram of a system server for virtual consultations and attorney referrals in accordance with at least one embodiment disclosed herein. As shown in FIG. 2A, the system server 105 of the system 100 include various hardware and software components that serve to enable operation of the system, including one or more processors 110, a user interface 115, a memory 120, a microphone 125, one or more software modules 130, a display 140, a camera 145, a communication interface 150, an audio output 155, one or more sensors 160, one or more databases 185, and a storage 190. Processor 110 serves to execute a client application in the form of software instructions that can be loaded into memory 120. Processor 110 can be a number of processors, a central processing unit CPU, a graphics processing unit GPU, a multi-processor core, or any other type of processor, depending on the particular implementation.

Preferably, the memory 120 and/or the storage 190 are accessible by the processor 110, thereby enabling the processor 110 to receive and execute instructions encoded in the memory and/or on the storage so as to cause the mobile device and its various hardware components to carry out operations for aspects of the systems and methods as will be described in greater detail below. Memory 120 can be, for example, a random access memory (RAM) or any other suitable volatile or non-volatile computer readable storage medium. In addition, the memory 120 can be fixed or removable. The storage 190 can take various forms, depending on the particular implementation. For example, the storage 190 can contain one or more components or devices such as a hard drive, a flash memory, a rewritable optical disk, a rewritable magnetic tape, or some combination of the above. Storage also can be fixed or removable.

One or more software modules 130 are encoded in the storage 190 and/or in the memory 120. The software modules 130 can comprise one or more software programs or applications having computer program code, or a set of instructions executed in the processor 110.

FIG. 2B display a block diagram of software modules for virtual consultations and attorney referrals in accordance with at least one embodiment disclosed herein. With reference to FIGS. 2A-2B, included among the software modules 130 is, preferably, a user interface module 170, an enrollment module 172, a payment module 174, a communication module 176, an attorney selection module 178, and a database module 180 that are executed by processor 110. Such computer program code or instructions configure the processor 110 to carry out operations of the systems and methods disclosed herein and can be written in any combination of one or more programming languages.

With reference again to FIG. 2A, the program code can execute entirely on the system server 105 as a stand-alone software package, partly on system server 105, partly on the user device 101a/101b, or entirely on user device 101a/101b or another remote computer/device 102. In the latter scenario, the remote computer can be connected to system server 105 through any type of network, including a local area network (LAN) or a wide area network (WAN), mobile communications network, cellular network, or the connection can be made to an external computer (for example, through the Internet using an Internet Service Provider).

In one or more embodiments, the program code of software modules 130 and one or more computer readable storage devices (such as memory 120 and/or storage 190) form a computer program product that can be manufactured and/or distributed in accordance with the present invention, as is known to those of ordinary skill in the art.

In one or more embodiments, one or more of the software modules 130 can be downloaded over a network to storage 190 from another device or system via communication interface 150 for use within the system 100. Additionally, other information and/or data relevant to the operation of the present systems and methods (such as database 185) can also be stored on storage.

With continued reference to FIG. 2A, in one or more embodiments, a database 185 is stored on storage 190. As will be described in greater detail below, the database contains and/or maintains various data items and elements that are utilized throughout the various operations of the system 100 and method for virtual consultations and attorney referrals. The information stored in database can include but is not limited to user enrollment data, user location data, attorney user license/qualification data, peer ratings, and payment information, as will be described in greater detail herein. It should be noted that although database 185 is depicted as being configured locally to user device 101a/101b, in certain implementations the database and/or various of the data elements stored therein can, in addition or alternatively, be located remotely (such as on a remote device 102 or user device 101a/101b—not shown) and connected to system server 105 through a network in a manner known to those of ordinary skill in the art.

A user interface 115 is also operatively connected to the processor 110. The interface 115 can be one or more input or output device(s) such as switch(es), button(s), key(s), a touch-screen, microphone, etc. as would be understood in the art of electronic computing devices.

In one or more embodiments, the user interface 115 can execute partly or entirely on the user device 101a/101b. For example, the user interface 115 can facilitate the capture of commands from the user such as an on-off commands or user information and settings related to operation of the system 100 for virtual consultations and attorney referrals. For example, in at least one embodiment, the interface 115 can serves to facilitate the capture of certain information from the user device 101a/101b such as personal user information for enrolling with the system so as to create a user profile (e.g., attorney profile, client profile).

The system server 105 can further include a display 140 which is also operatively connected to the processor 110. The display 140 includes a screen or any other such presentation device which enables the system to instruct or otherwise provide feedback to the user regarding the operation of the system 100 for virtual consultations and attorney referrals. For example, the display can be a digital display such as a dot matrix display or other 2-dimensional display. In at least one embodiment, the interface 115 and the display 140 can be integrated into a touch screen display. In at least one embodiment, the display 140 can be used to show a graphical user interface, which displays various data and provide “forms” that include fields that allow for the entry of information by the user. Touching the touch screen at locations corresponding to the display of a graphical user interface allows the person to interact with the device to enter data, change settings, control functions, etc. So, when the touch screen is touched, user interface communicates this change to processor, and settings can be changed, or user entered information can be captured and stored in the memory.

System server 105 can also include a camera 145 capable of capturing digital images and videos. In addition, the system server 105 can also include one or more microphones 125 for capturing audio recordings and for communication with as would be understood by those skilled in the art.

Audio output 155 is also operatively connected to the processor 110. Audio output can be any type of speaker system that is configured to play electronic audio files as would be understood by those skilled in the art. Audio output can be integrated into the system server 105 or external to the system server 105.

Various hardware devices/sensors 160 are also operatively connected to the processor 110. The sensors 160 can include: an on-board clock to track time of day, etc.; a GPS enabled device to determine a location of the user device 101a/101b; Gravity magnetometer to detect the Earth's magnetic field to determine the 3-dimensional orientation of the user device 101a/101b; proximity sensors to detect a distance between the user device 101a/101b and other objects; and other such devices as would be understood by those skilled in the art.

With continued reference to FIG. 2A, a communication interface 150 is also operatively connected to the processor 110 and can be any interface that enables communication between system server 105, user devices 101a and 101b, and external devices, machines and/or elements including remote computing device 102. Preferably, communication interface includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the system server 105 to other computing devices and/or communication networks such as private networks and the Internet. Such connections can include a wired connection or a wireless connection (e.g. using the 802.11 standard) though it should be understood that communication interface can be practically any interface that enables communication to/from the system server 105.

It should be understood that in one or more embodiments, user devices 101a/101b and/or remote device 102 can include some or all of the features of system server 105 as shown in described in FIGS. 2A and 2B.

At various points during the operation of the system 100 for virtual consultations and attorney referrals, the system server 105 can communicate with one or more computing devices, such as user devices 101a/101b and/or remote computing device 102. Such computing devices transmit and/or receive data to/from system server 105, thereby preferably initiating maintaining, and/or enhancing the operation of the system 100, as will be described in greater detail below.

The present systems and methods include various features related to attorney referrals and payment of fees for attorney referrals in accordance with one or more embodiments. Several of these features are defined and summarized below.

Referral Initiation and Initial Connection Premium

In one or more embodiments, a referral is initiated when the system server 105 receives a request from the user device of a legal professional user (attorney user) to transfers a client user to another attorney user for the purpose of obtaining legal assistance. In one or more embodiments, to initiate the referral, the processor of the system server is configured to interact with the network communication interface 150 and the computer readable storage medium 190 (e.g., storage 190) and execute one or more software modules 130 stored on the storage medium, such as the attorney selection module 178, in order to perform the initiation referral. The request can be sent by the user device via its user interface (e.g., button, hyperlink).

The “initial connection premium” is an amount paid to the attorney user who makes the initial connection with a client user in the present system. In one or more embodiments, the payment can be initiated by the processor of the system server 105, which is configured to execute one or more software modules, such as the payment module 174. In one or more embodiments, this initial connection premium is fixed or proportionately related to the time each attorney user spends connected to a client user via a virtual consultation (e.g., audio or video consultation), up to the point of initiating a referral. The system server 105 can be configured to initiate a payment in response to receiving a signal indicating that the virtual consultation has ended or that a referral request has been made, for example. In one or more embodiments, the system server 105 of the present system can be configured to operatively connect to one or more financial institutions (e.g., banks) and/or corporations that specialize in payment card services, of which the attorney users and client users can be associated with in order to facilitate payment between the client users and attorney users as is known and understood in the art.

Lead Generation Fee and Lead Generation Proration

Conventionally, attorneys pay for leads generated by a plethora of available online lead generation services. Such services often require a contract between the attorney and the service. These online services also typically charge for time and expenses incurred, such as vetting potential clients, when generating a lead. Conventional lead generation services, however, often offer inferior leads as clients are often vetted by non-attorneys.

In contrast, in the present methods and systems each attorney user can vet and generate their own lead. In one or more embodiments, attorney users are compensated for the time incurred in generating each lead. For instance, the “lead generation fee” of the present system is the amount received by an attorney user who evaluates a client user within the system (by, for example, positing questions to unearth the practice area most aligned with the client user's legal issue), minus an initial connection premium if applicable. In one or more embodiments, the processor of the system server 105 can be configured to monitor the amount of time spent by an attorney user evaluating a client user while logged into the system, and generate an amount for the lead generation fee once the attorney user has concluded his or her lead generation activity for a particular client user, such as when the attorney user makes a referral request for that client user.

In one or more embodiments, the amounts paid to an attorney user involved in a particular referral relationship can include a portion of the remainder of the lead generation fee (less the initial connection premium, if applicable) that is proportional to the time each attorney user spends connected to a client user during his or her initial call and up to the point of initiating a referral. The system server 105 can be configured to determine the amount of the fee due to each attorney in a referral by monitoring or tracking the time each user device is engaged (e.g., virtual consultation) with the particular client device, for example.

More specifically, in at least one embodiment, the processor of the system server 105 is configured to monitor activity of user devices (including time and date information) and is configured to track the time lapsed for each virtual consultation session. The system server 105 is also configured to parse user connections (time the user spends actively logged into the app, for example) to identify the initial connection between each attorney user and a referred client user. The initial connection starts a count of time that lapses at the initiation of an attorney referral for the client user, to gather how long a particular attorney user has engaged with a client user. The system server 105 uses engagement time and other data to calculate the portion of the lead generation fee owed to each attorney user engaged in a referral relationship. For example, in at least one embodiment, to determine the amount paid to a particular legal professional user engaged in a referral relationship, the system server subtracts the initial connection premium from the lead generation fee and multiplies the result by the percentage of a particular attorney user's engagement time.

Referrals and Referral Integrity Delay

The referral integrity delay refers to a feature of the present methods and system that mitigates system abuse by attorney users and promotes superior referral services for all users. In one or more embodiments, the processor of the system server 105 is configured to monitor virtual consultations between an attorney user and a client user, and prevent for an adjustable period of time, such as during the first 15-30 minutes or the first 15 minutes of any connection, an attorney user from making a referral request to another attorney. This feature acts as a redundancy to hinder attorney user's seeking to abuse the system by, for example, fielding virtual connections with different client users in volume and quick succession, for the primary purpose of gaining a referral (and a subsequent fee), without conducting a reasonable legal consultation with the client user. Such practices may lead to client users being referred multiple times for the same concern. In one or more embodiments, if an attorney attempts to submit a referral request during the delay period, the processor of the system server 105 can be configured send an error message to the user device or to display an error message within the user interface of the user device, for example. In at least one embodiment, the processor can configure the user interface of the user device to enforce the referral delay by not allowing a referral request until after the delay period has elapsed. For example, the processor can be configured such that the hyperlink or button for requesting a referral in the user interface of the user device only appears after the delay period has elapsed.

Only after the adjustable period of time has lapsed (e.g., 15 minutes) after the attorney user initiates a connection with a client user will the attorney user have the option of referring the client user to another more suitable attorney user. Reasonable consultations and proper referrals ostensibly provide superior service for the client user and all attorney users involved in a referral relationship.

In an exemplary embodiment, the processor of the system server is configured to receive time and date information from user devices and is configured to track each virtual consultation session, analyze and monitor various user connections, identify the initial connection between the legal professional user and client user, and start a count of time lapsed post initial connection. At the target time after initial connection (e.g., 15 minutes), the processor configures the user interface of the attorney user device to display a functioning (previously indiscernible or nonfunctioning) referral button or link capable of initiating a referral of the client user to another attorney user. A referral is then requested when the attorney user engages the appropriate button or link, sending a signal to the system server 105, which upon receipt, is configured to initiate the referral of the client user to another attorney user.

Direct Referral and Referral Control

Attorney users may refer a client user directly to a particular attorney user or system server can be configured to choose the most suitable legal professional, as discussed in further detail below.

In one or more embodiments, an attorney user may connect with another attorney user by using the in-system invitation mechanism. In using the in-system invitation mechanism, the processor of a system server 105, executing one or more software modules (e.g., user interface module, enrollment module, communication module, attorney selection module, database module) is configured to search for other legal professionals, send invitations to and receive invitations from other legal professionals, and connect attorney users with one another. Once connected, attorney users appear in each other's contact lists. In one or more embodiments, legal professional users may choose to directly refer client users to any legal professional user in their contact list, except in situations in which the system server may, for the benefit of the client user, decline the referral. In at least one embodiment, the system server 105 is configured to send invitations to legal professionals who are not already enrolled in the community, where the invitation invites them to enroll in and join the community.

In one or more embodiments, after the initiation of an attorney referral, the system server determines whether the client user and attorney user to whom the client user has been referred are suitably aligned, and therefore whether the referral may proceed. More specifically, the processor of the system server 105, executing one or more software modules (e.g., attorney selection module), is configured to analyze various data points of the client user (e.g., location, legal issue) and various data points of the attorney user (e.g., location, jurisdictions attorney is licensed in, peer reviews, practice area, availability) to whom the client user was referred to determine whether they are suitable aligned. For example, the system server may cross reference data points of the client user and attorney user and decline the direct referral (i.e., “referral control”) where the referred attorney user's practice area is not aligned with the client user's stated legal concerns, or where the attorney user's peer reviews falls below a required threshold.

For example, in an exemplary embodiment, the user interface for the action of direct referral can include, for example, a hyperlink or button capable of initiating a direct referral, a hyperlink or button capable of accessing the referring attorney user's contact list, a hyperlink or button capable of searching or selecting an attorney contact from said list to whom the case shall be referred, and a hyperlink or button to complete the referral. The direct referral action can further include a referral control step in which the system server 105 employs an algorithm (e.g., part of the attorney selection module 178) to determine whether the referral may proceed. For example, the processor of the system server can be configured to evaluate the initial client user's request, and credentials, practice locations or jurisdictions, practice area, and peer review rating thresholds of the prospective legal professional receiving the referral. Should the system server decline the direct referral, in one or more embodiments the processor of the system server is configured to indicate to the user device (via the user interface) that the direct referral has been declined. In one or more embodiments, the system server is configured to provide the attorney user with the option (e.g., via a hyperlink or button) to request direct referral of the client user to another legal professional contact or to instead use the system's automated referral system. In at least one embodiment, in the event of a declined direct referral, the processor of the system server is configured to automatically initiate an automated referral.

Automated Referral and System Abuse Control

For an automated referral, the system server is configured to evaluate available attorney users to determine the most suitable attorney user for a particular client user. An automated referral can be initiated by an attorney user via a user device 101a or by the system server 105 in response to a declined directed referral. In one or more embodiments, once an automated referral is initiated or requested, the processor of the system server 105, executing one or more software modules (e.g., attorney selection module), is configured to analyze multiple factors to determine the most qualified available attorney to be referred to the particular client. For instance, these factors can include but are not limited to: attorney's jurisdiction, attorney's practice area or expertise, length of experience, availability, public legal information about the attorney such as dispositions, pleadings content and count, the client user's legal concerns (e.g., legal issues), and input from the referring attorney user.

In an exemplary embodiment for the automated referral step, the user interface for requesting an automated referral can include, for example, a hyperlink or button capable of initiating a referral, an input field capable of receiving and storing user entered notes (e.g., stored in database 185 by executing database module 180), and a hyperlink or button capable of initiating editing of an automatically generated system referral note.

In one or more embodiments, the automated referral step can further comprise a referral control step in which the processor of the system server 105, executing one or more software modules (e.g., attorney selection module), is configured to determine whether the referral may proceed based on, for example, an adjustable peer review rating threshold of the referring attorney user and the amount of time elapsed between the attempted referral and the referring attorney user's most recent successful referral. Should the automated referral be declined (e.g., because target attorney user does not accept referral, or peer review rating falls below threshold subsequent to referral initiation), the processor of the user device or system server is configured to indicate to the user device (via the user interface) that the automated referral has been declined.

Referral Alert to Legal Professional User

In one or more embodiments, the processor of the system server 105, executing one of more software modules, is configured to alert a qualified attorney user of a pending referral using a variety of methods, including but not limited to, in-system or in-application messaging, push notifications, SMS/MMS, and email. In one or more embodiments, referral alerts can comprise both user input and algorithmically generated data. For example, user input can include, among other information, limited notes entered into a designated field by the referring attorney user and a client user selection summary based on the client user's initial consultation request. Algorithmically generated data can include but is not limited to, a rating of the quality of the referral determined by, for example, parsing attorney user notes, analyzing the referral rating of attorney user pulled from aggregated peer ratings, the amount of time lapsed on the initiating call prior to referral, practice area match, and similarity of the instant referral to a prior accepted referral.

Referral Consummation

In one or more embodiments, the system server is configured to consummate or verify a referral once the system server receives an acceptance from 1) the attorney user who has been referred to the client user and 2) the client user. The attorney user can accept a referral by selecting or actuating the appropriate hyperlink or button in the user interface of the user device, thereby sending the acceptance to the system server. Likewise, the client user can accept the referred attorney by selecting or actuating the appropriate hyperlink or button in the user interface of the user device, which sends the acceptance to the system server. After the system server receives the acceptances from the attorney user and the client user, the processor of the system server, by executing one or more software modules (e.g., communication module), is configured to connect the referred attorney user and the client user (e.g., virtual consultation; enabling virtual chat between the attorney user and client user).

Automated Referral Management

In one or more embodiments, the processor of the system server is configured to automatically send and receive communications between attorney users and client users engaged in a referral relationship. These communications can include, but are not limited to, email, in-system or in-application messaging, and push notifications.

The automated communications can comprise relevant case information including but not limited to readily available public information from sources such as the Public Access to Court Electronic Records (PACER) service, and various news services. In one or more embodiments, the processor of the system server 105, executing one or more software modules (e.g., communications module), can be configured to aggregate the content of the automated communication and relay the aggregated content to attorney users or the client users engaged in a referral relationship using any number of methods such as in-system summaries and external links. For instance, in one exemplary embodiment, the system server can be configured to send an attorney user case information about multiple cases referred to that attorney user, including but not limited to, case referral date, case update requests with suggested response options, referral fee due status with suggested response options referred cases count, referral handling, and payment quality. In at least one embodiment, the case information for an individual pending case can include but is not limited to an initial referral date, automatic case news/progress, relevant external links, manually uploaded attorney user case updates, referral fee status, and prepackaged deployable communication content for the purposes of prompting and responding to attorney users engaged in a referral relationship.

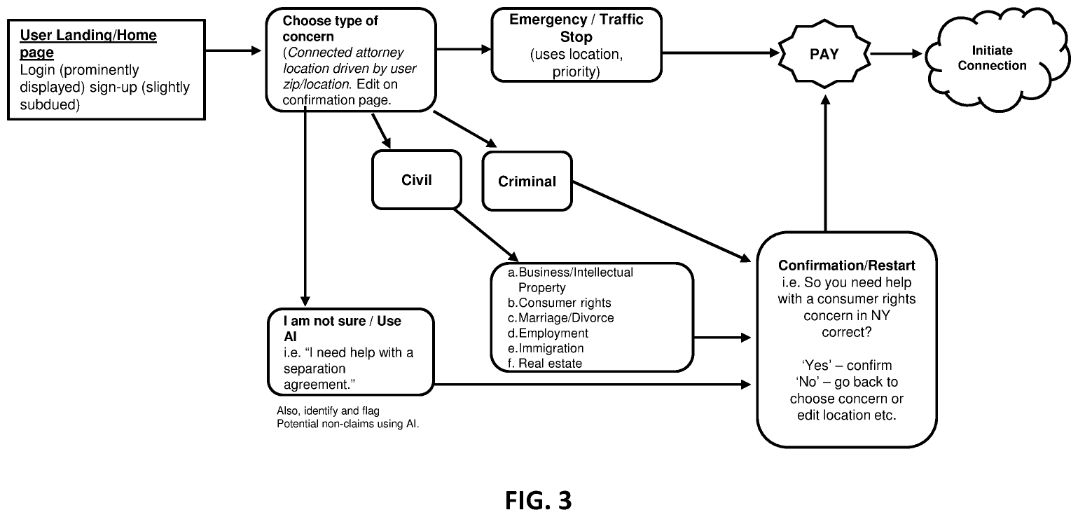

Exemplary methods of the present application for arranging a virtual consultation and attorney referral are now described in further detail, with reference to FIGS. 3-5. FIG. 3 displays a block diagram showing an exemplary enrollment and sign-in process for a client user in accordance with one or more embodiments.

With reference now to FIG. 3, to begin the enrollment process for the client user, a client user signs up to join the present system (referral community) as a client user. In one or more embodiments, the sign-up can be done via an app operating on a user device (e.g., smartphone, laptop, tablet, personal computer) or via a website. For example, in the instance of an app, the processor of the client's user device, by executing one or more software modules of the present application, is configured to prompt the client user via the user interface for login and biographical information (e.g., biographical information about the user such as name, address, payment information, and login information such as a username and password) as is known and understood in the art. Once the client user is signed into the app or website, the processor is configured via the user interface to prompt the client user to select a type of legal concerns. Via the user interface (e.g., using buttons or hyperlinks), the user can select one or more legal concerns from a drop-down menu, for example. In one or more embodiments, the drop-down menu can be separated into two categories, civil and criminal, with each category having a subsequent drop-down list for more specific legal concern for selection by the client user. In one or more embodiments, the user interface can include a hyperlink or button in which the client user can select that they are “not sure” which legal concerns in the drop-down menu are applicable to their situation. Upon selection of this button or hyperlink, the processor of the client user device is configured to display a text box allowing the client to enter in their legal concerns in plain text in the user's own words. Once the legal concerns have been entered into the text box and submitted, the processor executing one or more software modules of the present application, is configured to use a legal issues algorithm to determine the most applicable legal issues for the user based on their plain text submission. As such, the legal issues of the client are determined either by the drop-down menu selection or via plain text submission.

In at least one embodiment, an “emergency” can be selected by the client user as the legal issue drop-down menu. Emergencies can include a traffic stop, for example. Upon selection of “emergency” as the legal issue, the processor of the system server is configured to prompt the client user device for the user's location and priority (e.g., how urgently legal assistance is required). In at least one embodiment, the system server can be configured to automatically retrieve the location data of the client user device via a GPS-enable sensor of the client user device. Upon entry or retrieval of this location information, in one or more embodiments, the processor of the system server is configured to expedite initiation of a connection (e.g., audio call, video consultation) with the next available attorney user. For instance, in an exemplary embodiment, upon receipt of an “emergency” selection from the client user, the system server is configured to parse the database for available criminal attorneys registered in the jurisdiction corresponding to the location of the client user, and among the attorneys with the matching jurisdiction, select an attorney that is immediately available (e.g., logged in to the system and determined to be available based on their current case load).

In at least one implementation, the system server requires payment of a fee by the client user before initiation an emergency connection with an attorney user. In at least one embodiment, approval of a payment bypass request can be accepted in lieu of payment. More specifically, in at least one embodiment, the client user can submit a payment bypass request in certain situations, such certain emergency situations (e.g., a police stop) or where the user is indigent. If the client user meets certain criteria (e.g., immediate police contact, indigency, etc.) the system server (by executing the payment module 174) is configured to approve the payment bypass request and connect the client user to an attorney user without payment of a fee. In at least one embodiment, an attorney user that is notified of a new client matter that includes an approved payment bypass request would be notified that it is a pro bono matter, and can then decide whether or not to engage with the client user without a negative effect on their rating.

The payment bypass request can be implemented in number of ways. For example, in least one implementation, the processor can be configured such that a hyperlink or button for requesting to bypass payment appears in the client user interface after “emergency” is selected as the legal issue from the drop-down menu. After selection the button or hyperlink, the processor can be configured to prompt the user via the user interface to select one or more reasons for the payment bypass request from a drop-down menu or by entered the reasons via the keyboard. After entering the reasons for the request, the processor can be configured to approve of the request and initiate a legal consultation with an available legal professional.

In at least one embodiment, a payment bypass request can be initiated by entering a code into specialized URL.

In one or more embodiments, once the (non-emergency) legal issue(s) of the client user has been determined (e.g., via drop-down menus or plain text submission), the processor of the system server can be configured to prompt the client (via user interface of client device) to confirm their legal issue (e.g., via actuation of a button or hyperlink).

In one or more embodiments, once the one or more legal issues have been selected and/or confirmed by the user, the processor of the client device can be configured to prompt the client for an initial payment for an initial virtual consultation. In one or more embodiments, the processor of the of the user device (e.g., by executing the payment module 174) is configured to operatively connect to one or more financial institutions (e.g., banks) and/or corporations that specialize in payment card services, of which the client user is associated with in order to facilitate payment from the client user. Upon receipt of payment bypass approval or payment, the processor of the user device is configured to initiate a legal consultation with an available legal professional. In subsequent interactions with the app or website of the present system, a client user may be prompted to enter their username and/or password to gain access to their account.

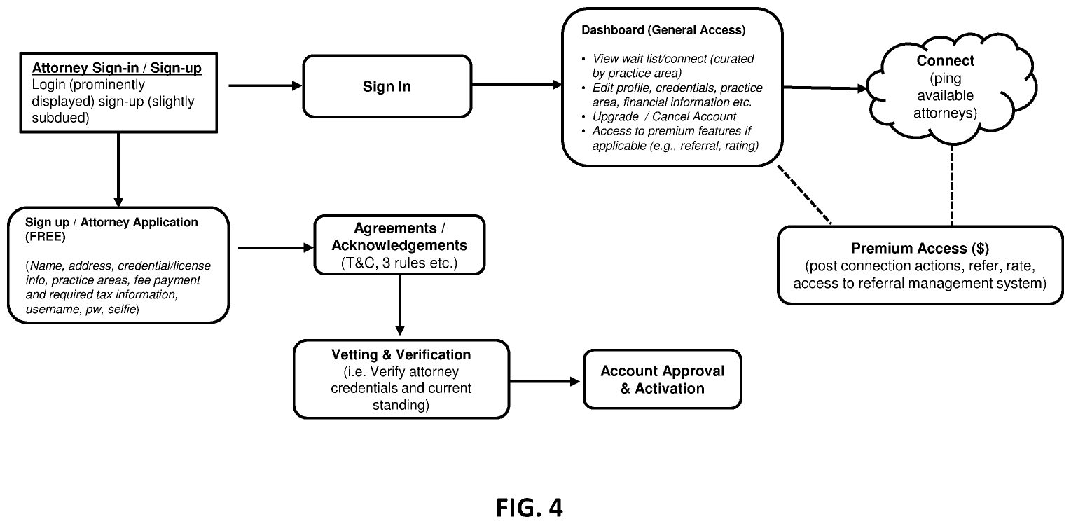

FIG. 4 displays a block diagram showing an exemplary enrollment and sign-in process for an attorney (legal profession) user in accordance with one or more embodiments.

With reference now to FIG. 4, to begin the enrollment process for an attorney user, an attorney user signs up to join the present system (referral community) as an attorney user. In one or more embodiments, like the sign-up for client users, the sign-up for attorney users can be done via an app operating on a user device (e.g., smartphone, laptop, tablet, personal computer) or via a website. For example, in the instance of an app, the processor of the client's user device, by executing one or more software modules of the present application, is configured to prompt the attorney user via the user interface for login and biographical information (e.g., biographical information about the user such as name, address, credentials, license information, practice areas, payment information, and tax information, and other information such as a username, password, and a recent picture) as is known and understood in the art.

In one or more embodiments, prospective attorney users must undergo additional approvals and vetting before their user account is activated. For example, the prospective user attorney user can be required to review and sign one or more agreements for joining the referral community, such as a “Term and Conditions” agreement. In one or more embodiments, the “Terms and Conditions” (“T & C”) for the present system can include three primary rules (“3 rules”): 1) attorneys must be licensed and in good standing in the applicable jurisdiction; 2) attorneys must possess liability insurance and agree to hold the community/platform harmless for any claims that arise out of their use of the system; and 3) attorneys must field all calls directly and agree never to have a third party field a call under their user ID. In one or more embodiments, the processor of the user device can be configured to check an attorney's credentials prior to granting access to the system and periodically while the attorney is actively engaged with the system.

In one or more embodiments, the prospective attorney user's credentials (e.g., license to practice law in one or more jurisdictions) can also be vetted and confirmed prior to activation of their account. For instance, the processor of the attorney user's device can be configured to send the attorney's inputted credentials to the system server or one or more remote computer devices 102 or the system server 105, which can be configured to confirm the validity of the license information. Upon confirmation of the validity of the license information, the attorney user device is configured to receive a confirmation of approval of their user account (e.g., via in-app messaging, push notifications, SMS/MMS, and email, etc.). Once the attorney user account is approved, in subsequent interactions with the app or website of the present system, the attorney user may be prompted to enter their username and/or password to gain access to their account.

Once the attorney user is signed into the app or website, the processor of the user device is configured via the user interface to display a dashboard with various selection and input options (e.g., buttons, hyperlinks), including but not limited to viewing a wait list of potential clients to connect with (e.g., curated by practice area), view a list of attorney users to connect with, and editing the attorneys account information (e.g., biographical/profile information, legal credentials and license information, practice area, payment information). In at least one embodiment, the dashboard can also include an option to upgrade the attorney account or cancel and attorney account, for example. In such an embodiment, attorney accounts may be upgraded to a premium account, which allows for premium access to various features of the system in exchange for an added fee paid by the attorney user. The premiums access features can include but are not limited to the ability to track referrals, rate other attorney users, and various other actions that can be performed after an initial connection with a prospective client.

To connect with a prospective client or another attorney user, an attorney user can engage with the wait list of prospective clients or the list of attorney users. In certain instances, depending upon required access (e.g., attorney license information) and availability, upon engagement with a particular client or attorney user in the dashboard, the processor of the user device is configured to connect to the user device of the client or other attorney user (e.g., audio chat, video chat, in-app messaging, email, etc.).

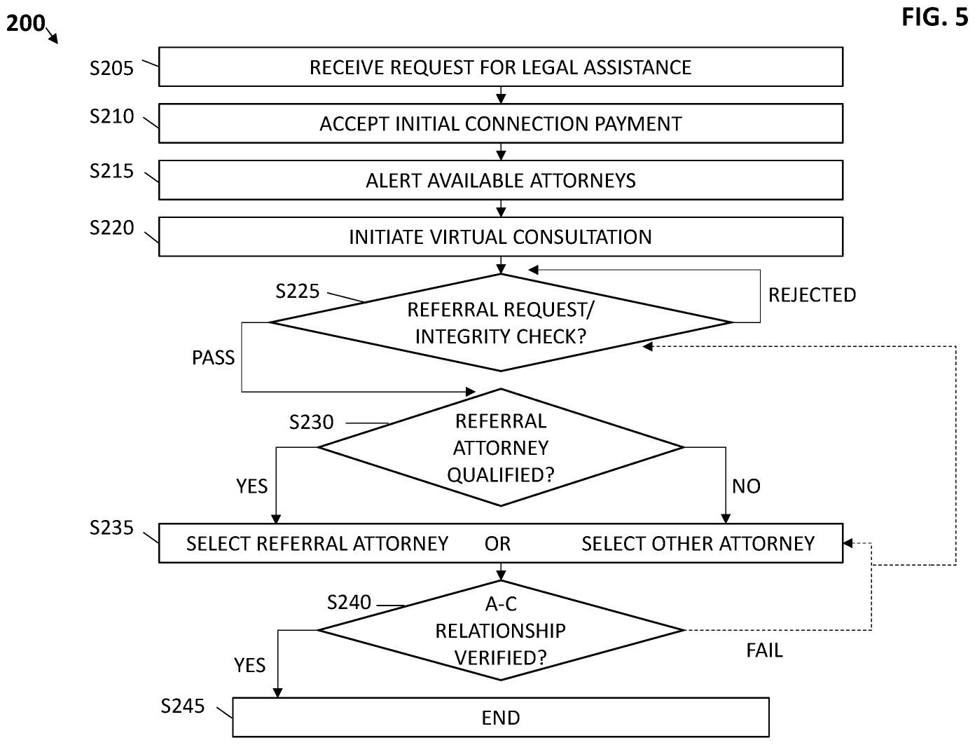

FIG. 5 displays a flow diagram of an exemplary method for arranging a virtual consultation and attorney referral between attorney users and a client user in accordance with one or more embodiments. It is noted that while the following exemplary method is discussed as being performed by a single computing device (e.g., system server 105) with processor 110 executing one or more software modules 130 (see FIGS. 2A-2B), in one or more embodiments, the method can be performed similarly by one or user devices 101a/101b or one or more system servers 105 or one or remote computing devices 102 or a combination thereof. It is also noted that the attorney users and client users in the following method are already enrolled in the system/referral community, as discussed above.

With reference now to FIG. 5 and FIGS. 2A-2B, the method 200 begins at step S205, where the processor of the computing device (e.g., system server 105) is configured by executing one or more software modules (e.g., user interface module 170, attorney selection module 178) to receive a request for legal assistance from a client user. The request for legal assistance can include at least one legal issue of the client. In at least one embodiment, the request for legal assistance can further include at least one of a location of the client user, a location of the legal issue, and an estimated budget of the client user. In at least one embodiment, the system server 105 can be configured to automatically determine the location of the client user based on GPS location information from the client user device. At step S210 the processor of the computing device is configured by executing one or more software modules (e.g., payment module 174) to accept an initial connection payment from the client user. In one or more embodiments, the computing device (system server 105) can be configured to operatively connect to one or more financial institutions (e.g., banks) and/or corporations that specialize in payment card services, of which the user(s) are associated with in order to facilitate payment from the client user.

In at least one embodiment, approval of a payment bypass request can be accepted in lieu of payment at step S210. More specifically, in at least one embodiment, the client user can submit a payment bypass request in certain situations, such certain emergency situations (e.g., a police stop) or where the user is indigent. If the client user meets certain criteria (e.g., immediate police contact, indigency, etc.), and the payment bypass request is approved, as previously discussed, the system server is configured to bypass the step of payment of a fee at step S210. With continued reference to FIGS. 5 and 2A-2B, at step S215, the processor of the computing device is configured by executing one or more software modules (e.g., communication module 174) to alert available attorneys of the request for legal assistance of the client user. In one or more embodiments, as part of step S215, the computing device (system server 105) is configured to identify and select attorneys logged into the referral network as those attorneys who will receive the alert. In one or more embodiments, the processor can be configured to send alerts to the user devices of all available attorneys that are currently signed into the system (e.g., signed into the app or website) using a variety of methods, including but not limited to, in-system or in-app messaging, push notifications, SMS/MMS, and email. As used herein “available attorneys” generally refers to attorney who are logged into the referral network. In one or more embodiments, the processor can be configured to only send alerts to attorney users that meet certain additional criteria, such as available attorney users of a particular general practice area (e.g., civil or criminal) related to the legal issues of the client user, or available attorneys with a case load below a certain threshold amount.

At step S220, the processor of the computing device is configured by executing one or more software modules (e.g., communication module 174) to initiate a virtual consultation with the client user upon receiving an initiation request from an initiating attorney from among the available attorneys. The “initiating attorney” is an attorney that is among those that were alerted at step S215 of the request for legal assistance and is the first one to respond to the request for legal assistance. In one or more embodiments, once the initiating attorney submits an initiation request via the user interface of the attorney user device, the system server is configured to prompt the client user device (e.g., push notification) to accept the request. In one or more embodiments, upon acceptance, the system server automatically connects the client user to the initiating attorney for a virtual consultation. Alternatively, in at least one embodiment, the system server is configured to prompt the client user device, upon acceptance, to select a time and date for a virtual consultation with the initiating attorney that is more convenient for the client user (e.g., via one or more drop-down menus). The virtual consultation between the initiating attorney and the client user can be audio-only chat or a video chat, and in one or more embodiments, the client user can select their preferred method for the consultation. In instances in which either the initiating attorney or the client user does not have access to video chat, the system server will automatically initiate the virtual consultation as an audio-only chat.

In one or more embodiments, an attorney must be licensed in the jurisdiction in which they field calls. For instance, if a client user's legal issues are related to the state of New York, any attorney who takes part in a virtual consultation with that client user must be a licensed attorney in good standing in the state of New York. Likewise, for a client user who legal issues involve federal matters, an attorney involved in a virtual consultation with that client user must be admitted in at least one federal district court. Similarly, in one or more embodiments for immigration matters, a consulting attorney must be registered with the Executive Office for Immigration Review (EOIR). In one or more embodiments, the processor of the system server is configured to verify the attorney's license information before a virtual consultation is started between the attorney and a client user. Additionally, in at least one embodiment, the processor can be configured to provide verification of the attorney's licensing and good standing to the client user before the virtual consultation or after the virtual consultation via an in-app message, pop-up notification, or push notification, for example.

In one or more embodiments, at the conclusion of a virtual consultation, the processor of the system server can be configured to prompt the client user on the client user device to provide a rating and a review of the initiating attorney. In one or more embodiments, the review and/or the rating can be used as part of the peer rating for that particular attorney, which can be used to determine whether the attorney receives priority for future referrals and consultations.

At step S225, the processor of the computing device is configured by executing one or more software modules (e.g., attorney selection module 178) to receive a referral request from the initiating attorney to refer the prospective client to a referral attorney. After the virtual consultation between the initiating attorney and the client user, if the initiating attorney would like to refer the case to another attorney, the initiating attorney can submit a referral request. Specifically, in one or more embodiments, in the user interface of the user device of the initiating attorney, the attorney can select an option (e.g., via button, hyperlink) to make a referral request, and subsequently the processor of the system server 105 is configured by executing one or more software modules 130 to receive the request. In at least one embodiment, the computing device (system server 105) can be configured to identify available attorneys among the attorneys that the initiating attorney is connected with in the referral community and provide a list of possible attorneys for the initiating attorney to choose from for making a referral request.

In one or more embodiments, the referral request specifies a particular attorney that the initiating attorney would like to refer the client to (the “referral attorney”) (e.g., via a drop-down menu of attorneys he or she is connected to in the system/referral community). In one or more embodiments, the referral attorney is an attorney already enrolled in the system/referral network, and in at least one embodiment, before the initiating attorney can refer someone to the client user, the initiating attorney must be connected to the referral attorney in the system/referral network.

In one or more embodiments, as part of step S225, the processor is configured to reject the referral request unless a predetermined period (“referral integrity delay”) following initiation of the virtual consultation has elapsed to ensure an adequate period for the virtual consultation. In one or more embodiments, the predetermined period or referral integrity delay is 15-30 minutes, or in a preferred embodiment 15 minutes. If the processor rejects referral request because the predetermined period has not elapsed, the method returns to before step S225, and a new referral request must be submitted before the method can continue. In such a situation, in one or more embodiments, the system server is configured to send a rejection communication to the user device (e.g., in-app communication, push notification), which can prompt the initiating attorney to honor the referral integrity delay period. In one or more embodiments, the processor of the system server is configured to monitor the time elapsed during the virtual consultation and automatically reject an attempt at a referral (e.g., transmitting error message to initiating attorney user device) if the predetermined period has not elapsed.

At step S230, upon receipt of the referral request, the processor of the computing device is configured by executing one or more software modules (e.g., attorney selection module 178) to determine whether the referral attorney is qualified to represent the client user. In one or more embodiments, to make the determination, the processor is configured to do at least one of the following: review a current case load of the referral attorney, determine whether the at least one legal issue of the client user matches a practice area of the referral attorney; and determining whether a peer rating of the referral attorney is above a predetermined threshold. Regarding case load, in one or more embodiments, to the system server is configured to review the numbers of cases an attorney user is working on within the referral community to ensure that attorneys do not become overloaded with referrals. As such, in one or more embodiments, the processor is configured to determine whether the case load (e.g., total number of cases) of the referral attorney exceeds a threshold amount. This threshold amount can vary depending on the practice area of the attorney user and the types of cases they have been referred. In one or more embodiments, the threshold for case load can be preset by the referral attorney or by the client user.

As discussed previously, upon enrollment, attorney users enter their practice area(s) into the system/referral community. The practice areas can then be stored in the database 185 as being associated with the particular attorney user. During step S230, the processor is configured to evaluate whether the legal issues of the client user sufficiently matches the practice area of the referral attorney. In one or more embodiments, to evaluate a sufficient practice area match for the referral attorney, the processor is configured to consider and compare the listed practice areas of the other available attorneys versus the listed practice area(s) of the referral attorney. Regarding peer ratings, other enrolled attorneys can periodically provide peer ratings of other attorneys in the system/referral community to whom they have referred clients. The processor can then be configured to determine an average (or median) peer rating for the referral attorney and then compare the peer rating of the referral attorney to a predetermined threshold. In one or more embodiments, the predetermined threshold for peer rating can be determined by the client user. In at least one embodiment, the system server can be configured to provide a default threshold. In at least one embodiment, the system server is configured to compare with peer rating of the referral attorney to peer ratings of the other available attorneys, and determine whether the peer rating of the referral attorney is within a threshold amount of the peer ratings of other available attorneys.

Thus, in one or more embodiments, for the referral attorney to be determined as “qualified” to represent the client user, the referral attorney's case load must not to be too large (e.g., must not exceed a threshold amount), the referral attorney's practice area must match the one or more legal issues of the client user, and the peer rating of the referral attorney must exceed a predetermined threshold. In at least one embodiment, to determine whether the referral attorney is “qualified” the processor can also be configured to evaluate other factors, such as comparing an estimated budget of the prospective client with a billing rate of the referral attorney, comparing the location of the client user (or the location of the client user's legal issues) with the location and bar admission information associated with the referral attorney.

At step S235, the processor of the computing device is configured by executing one or more software modules (e.g., attorney selection module 178) to select the referral attorney as the handling attorney for prospective client or another available attorney as the handling attorney if the referral attorney is determined to be not qualified. As discussed above, if the referral attorney is determined to be “qualified”, then the referral attorney is selected as the handling attorney at step S235. In one or more embodiments, the system provides a preference for “qualified” referred attorneys to be selected as the handling attorneys to encourage more referrals and engagement from the attorney users. In one or more embodiments, when the referral attorney is determined to be “not qualified,” the processor is configured to generate a list of available attorney users and select the handling attorney from list of the available attorney users by evaluating one or more of the following characteristics of the available attorneys: current case load, primary area of practice, peer rating, billing rate, location, and bar admission. This type of selection of the handling attorney is referred to herein as “automated referral.” In one or more alternative embodiments, instead of referring the client user to a specific attorney (“direct referral”), the initiating attorney can opt to make an automated referral to allow the processor of the system server to automatically select the handling attorney based on the above characteristics or attributes of the available attorneys.

In at least one embodiment, following completion of the virtual consultation between the initiating attorney and the client user, the processor of the computing device is configured by executing one or more software modules (e.g., payment module 174) to provide an initial connection fee to the initiating attorney, wherein the initial connection fee is fixed or proportionate to the length of time of the virtual consultation.

It is noted that in at least one embodiment, non-attorney legal professionals cannot partake in attorney referral fees via this system. In such an embodiment, any referral agreements between attorneys and non-attorneys must be made outside of the system upon completion of a successful referral.

At step S240, the processor of the computing device is configured by executing one or more software modules (e.g., communications module 176) to verify an attorney-client relationship between the handling attorney and client user. To verify the attorney-client relationship, both the handling attorney and the client user must provide approval of the newly forming attorney-client relationship. In one or more embodiments, the approval can be provided via an electronic form (e.g., engagement letter) signed (or electronically signed) by the handling attorney and the client user. Upon receipt of the confirmation of approval from the handling attorney and the client user, the processor is configured to verify the attorney-client relationship.

In one or more embodiments, the selected attorney and/or the client user can reject the proposed attorney-client relationship. In the instance of a rejection of the relationship by either the selected attorney or the client user, the method can return to step S235 for a new automated referral or step S225 for a new direct referral and referral request. More specifically, in the instance of a rejection if the attorney-client relationship, the processor of the system server can be configured to prompt the initiating attorney to make another referral request for a different attorney user or to select automated referral. Upon selection of automated referral, the processor of the system server is configured to make a new selection for the best available attorney for the particular client user (step S235).

In one or more embodiments, as part of step S240, the processor of the system server is configured to verify the handling attorney's license(s) to practice in the jurisdiction(s) in which the legal issues of the client are related to. This provides an additional check on the handling attorney before the attorney-client relationship has been verified. The processor can be configured to check that the selected attorney's license is up to date in a particular jurisdiction by connecting to the legal jurisdiction's website or database and looking up the selected attorney. The processor can be further configured to look up in the jurisdiction website or database whether the selected attorney has any attorney disciplinary actions pending against them. In one or more embodiments, in an instance in which the selected attorney is determined as no longer licensed in the required jurisdiction for the legal issues of the client user, the processor can be configured to reject the verification of the attorney-client relationship. In at least one embodiment, if the selected attorney is licensed in a particular jurisdiction, but has an attorney disciplinary action pending against him or her, the processor can be configured to inform the client user of the pending disciplinary action against the attorney (e.g., via in-app communication, email, etc.) such that the client user can make an informed decision regarding whether to approve of the pending attorney-client relationship.

In one or more embodiments, the processor can be configured to periodically review attorneys' license information and attorney discipline information, such as during the attorney enrollment process (see FIG. 4) or at other points during the method 200, such as at step S215 as a prerequisite, such that attorneys are only alerted to a request for legal assistance if the attorneys are in good legal standing in their respective jurisdictions. In at least one embodiment, the processor can be configured to review the attorney license information (bar admission information) and attorney disciplinary information whenever an attorney logs into the referral network, or periodically based on when an attorney enrolls in the referral network (e.g., every month after initial enrollment). In at least one embodiment, upon a determination by the system server that an attorney is no longer in good standing in one or more jurisdictions in which they listed themselves as being licensed in, the system server can be configured to place a hold on the user account of the particular attorney user such that various features of the referral community are disabled for that attorney user (e.g., referral requests, virtual consultations) until the attorney can verify that they are attorneys in good standing in the particular jurisdictions or clarify that they are no licensed in certain jurisdictions, but are still in good standing in other jurisdictions. This can be done by updating the attorney's enrollment or user information, for example.

Once an attorney-client relationship between the handling attorney and the client user has been verified, the processor can optionally be configured by executing one or more software modules (e.g., communication module 176) to initiate a virtual consultation between the handling attorney and the client user or to prompt the client user to select a more convenient time for a virtual consultation with the handling attorney.

In one or more embodiments, the referral relationship, which includes the client user, the initiating attorney, and the handling attorney, is tracked for the duration of the client user's case. After the end of the client user's case, in one or more embodiments the handling attorney can rate the quality of the referral. The processor of the system server, executing one or more algorithms (e.g., a machine learning algorithm), can be configured to track the referral ratings of an attorney user over, along with other qualities of the attorney user, such as peer ratings, timeliness of referral fee payments, and satisfaction of client users. In at least one embodiment, the algorithm is trained on these various ratings and qualities such that the system server can be configured to better determine which attorneys should be alerted as “available attorneys” for particular types of cases at step S215, for example. The algorithm can also be trained on these ratings and qualities, as well as client user ratings after the conclusion of virtual consultations and at the conclusion of the overall representation of a client user by the handling attorney such that the processor of the system server is configured to better determine which attorneys are best suited for referrals for certain types of legal issues at step S235 (e.g., automated referrals).

In one or more embodiments, following completion of the virtual consultation between the handling attorney and the client user, the processor of the computing device is configured by executing one or more software modules (e.g., payment module 174) to provide a lead generation fee to the initiating attorney and the handling attorney, wherein the lead generation for each attorney is proportionate to the length of time spent in virtual connection with the client user. The processor can be configured to operatively connect to one or more financial institutions (e.g., banks) or corporations that specialize in payment card services, of which the attorney users and client users are associated with in order to facilitate payment to and from client users and attorney users. At step S245, the process ends.

Although much of the foregoing description has been directed to systems and methods for arranging a virtual consultation and attorney referral, the systems and methods disclosed herein can be similarly deployed and/or implemented in scenarios, situations, and settings far beyond the referenced scenarios. It should be further understood that any such implementation and/or deployment is within the scope of the systems and methods described herein.

It is to be further understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings are shown accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for arranging a virtual consultation and attorney referral, the method comprising:
receiving, by a computing device having a storage medium, instructions stored on the storage medium, and a processor configured by executing the instructions, a request for legal assistance from a prospective client, wherein the request includes at least one legal issue of the prospective client;
accepting, with the processor applying a payment module, an initial connection payment or a payment bypass request from the prospective client;
alerting, with the processor applying a communication module, available attorneys of the request for legal assistance of the prospective client;
initiating, with the processor applying the communications module, a virtual consultation between the prospective client and an initiating attorney upon receiving an initiation request from the initiating attorney, wherein the initiating attorney is an attorney among the available attorneys;
receiving, with the processor applying an attorney selection module, a referral request from the initiating attorney to refer the prospective client to a referral attorney;
determining, with the processor applying the attorney selection module, whether the referral attorney is qualified to represent the prospective client, wherein the step comprises:
reviewing a current case load of the referral attorney,
determining whether the at least one legal issue of the prospective client matches a practice area of the referral attorney, and
determining whether a peer rating of the referral attorney is above a predetermined threshold;
selecting, with the processor applying the attorney selection module, the referral attorney as a handling attorney for the prospective client or another available attorney as the handling attorney if the referral attorney is determined to be not qualified; and
verifying, with the processor applying the communications module, an attorney-client relationship between the handling attorney and the prospective client, wherein the step of verifying the attorney-client relationship comprises confirming approval of the attorney-client relationship with the prospective client and the handling attorney.

2. The method of claim 1, wherein when receiving the referral request, the processor is configured to reject the referral request unless the processor determines that a predetermined period following initiation of the virtual consultation has lapsed to ensure an adequate period for the virtual consultation.

3. The method of claim 2, wherein the predetermined period is 15-30 minutes.

4. The method of claim 1, further comprising:
providing, with the processor applying the payment module, an initial connection fee to the initiating attorney following completion of the virtual consultation, wherein the initial connection fee is fixed or proportionate to the length of time of the virtual consultation.

5. The method of claim 1, further comprising:
providing, with the processor applying the payment module, a lead generation fee to the initiating attorney and the handling attorney, wherein the lead generation for each attorney is proportionate to the length of time spent in virtual connection with the prospective client.

6. The method of claim 1, wherein the request for legal assistance from the prospective client further includes a location of the prospective client and wherein the step of determining whether the referral attorney is qualified to represent the prospective client further comprises:
comparing the location of the prospective client with location and bar admission information associated with the referral attorney.

7. The method of claim 1, wherein when the referral attorney is determined to be not qualified, the handling attorney is selected from a generated list of available attorneys by evaluating one or more of the following characteristics of each of the available attorneys: current case load, practice area, peer rating, billing rate, location, and bar admission.

8. A method for a virtual attorney referral, the method comprising:
initiating, by a computing device having a storage medium, instructions stored on the storage medium, and a processor configured by executing the instructions, a virtual consultation between a first attorney and a prospective client upon receiving an initiation request from the first attorney;
receiving from the first attorney, with the processor applying an attorney selection module, a referral request to refer the prospective client to a second attorney;
determining, with the processor applying the attorney selection module, whether the second attorney is qualified to take on the prospective client, wherein the step comprises:
reviewing a current case load of the second attorney,
determining whether at least one legal issue of the existing client matches a practice area of the second attorney, and
determining whether a peer rating of the second attorney is above a predetermined threshold;
selecting, with the processor applying the attorney selection module, the second attorney as a handling attorney for the prospective client or another available attorney as the handling attorney if the second attorney is determined to be not qualified; and
verifying, with the processor applying the communications module, an attorney-client relationship between the handling attorney and the prospective client, wherein the step of verifying the attorney-client relationship comprises confirming approval of the attorney-client relationship with the prospective client and the handling attorney.

9. The method of claim 8, wherein when receiving the referral request, the processor is configured to reject the referral request unless the processor determines that a predetermined period following initiation of the virtual consultation has lapsed to ensure an adequate period for the virtual consultation.

10. The method of claim 9, wherein the predetermined period is 15-30 minutes.

11. The method of claim 8, further comprising:
providing, with the processor applying the payment module, an initial connection fee to the first attorney following completion of the virtual consultation, wherein the initial connection fee is fixed or proportionate to the length of time of the virtual consultation.

12. The method of claim 8, further comprising:
providing, with the processor applying the payment module, a lead generation fee to the first attorney and the handling attorney, wherein the lead generation for each attorney is proportionate to the length of time spent in virtual connection with the prospective client.

13. The method of claim 8, wherein the step of determining whether the second attorney is qualified to represent the prospective client further comprises:
comparing a location of the prospective client with location and bar admission information associated with the second attorney.

14. The method of claim 8, wherein when the second attorney is determined to be not qualified, the handling attorney is selected from a generated list of the available attorneys by evaluating one or more of the following characteristics of each of the available attorneys: current case load, practice area, peer rating, billing rate, location, and bar admission.

15. A system for virtual consultations and attorney referrals, the system comprising:
a network communication interface;
a computer-readable storage medium;
a processor configured to interact with the network communication interface and the computer readable storage medium and execute one or more software modules stored on the storage medium, including:
an attorney selection module that when executed configures the processor to: receive a request for legal assistance from a prospective client, wherein the request includes at least one legal issue of the prospective client, receive a referral request from an initiating attorney to refer the prospective client to a referral attorney, and determine whether the referral attorney is qualified to be a handling attorney to represent the prospective client;
a payment module that when executed configures the processor to: accept an initial connection payment or a payment bypass request from the prospective client, provide an initial connection fee to the initiating attorney following completion of a virtual consultation, and provide a lead generation fee to the initiating attorney and the handling attorney; and
a communications module that when executed configures the processor to: alert available attorneys of the request for legal assistance of the prospective client, initiate a virtual consultation between the initiating attorney and the prospective client, and verify an attorney-client relationship between the handling attorney and the prospective client.

16. The system of claim 15, wherein the attorney selection module, when executed, configures the processor to receive the referral request only after a predetermined period following initiation of the virtual consultation, wherein the predetermined period is 15-30 minutes.

17. The system of claim 15, wherein the payment module, when executed, configures the processor to calculate the initial connection fee, wherein the initial connection fee is fixed or proportionate to the length of time of the virtual consultation.

18. The system of claim 15, wherein the payment module, when executed, configures the processor to calculate the lead generation fee for the initiating attorney and the handling attorney, wherein the lead generation for each attorney is proportionate to the length of time spent in virtual connection with the prospective client.

19. The system of claim 15, wherein the communications module, when executed, configures the processor to receive a confirmation of approval of the attorney-client relationship from the prospective client and the handling attorney in order to verify the attorney-client relationship.

20. The system of claim 15, wherein the attorney selection module, when executed, configures the processor to select the handling attorney based on an automated referral determination, wherein the processor is configured to select the handling attorney from a list of the available attorneys based on one or more of the following characteristics of the available attorneys: current case load, practice area, peer rating, billing rate, location, and bar admission.
